(19) United States
(12) Patent Application Publication
(10) Pub. No.: US 2018/0020636 A1
(43) Pub. Date: Jan. 25, 2018

(54) PET CARRIER INCLUDING ENERGY ABSORBING ELEMENTS

(71) Applicant: Ford Global Technologies, LLC, Dearborn, MI (US)

(72) Inventor: Para Valentine Weerappuli, West Bloomfield, MI (US)

(73) Assignee: Ford Global Technologies, LLC, Dearborn, MI (US)

(21) Appl. No.: 15/215,830

(22) Filed: Jul. 21, 2016

(51) Int. Cl. A01K 1/02

(52) U.S. Cl. CPC A01K 1/0272; A01K 1/0245

(57) ABSTRACT

A pet carrier includes an outer frame and an inner frame slidably coupled to the outer frame along an axis. The inner frame defines a pet compartment. An energy absorbing element is disposed between the inner frame and the outer frame along the axis. During a vehicle impact, momentum of a pet may move the pet toward the inner frame and may force the inner frame to slide relative to the outer frame. During this movement, the energy absorbing elements may absorb energy from the pet, softening the impact of the pet with the pet carrier.

### BACKGROUND

Pet owners may choose to travel with their pet. For example, the pet owner may travel with their pet in a vehicle, allowing the pet to sit unrestrained in the vehicle. This may allow the pet to wander about the vehicle and to interact with the pet owner while the vehicle is being operated. However, when the pet is unrestrained in the vehicle, the pet may become a projectile inside the vehicle if the vehicle is involved in a collision or otherwise impacted. Thus, the unrestrained pet in the vehicle during operation of the vehicle may increase potential injury to the pet and to human occupants of the vehicle.

### BRIEF DESCRIPTION OF THE DRAWINGS

FIG. 1 is a perspective view of a vehicle including a pet carrier in an undeployed position disposed on a seat.

FIG. 2 is a perspective view of FIG. 1 with a door of the pet carrier in an open position.

FIG. 3 is a perspective view of FIG. 1 including the pet carrier in a deployed position with deformed energy absorbing elements.

FIG. 4 is a perspective view of an outer frame of the pet carrier.

FIG. 5 is a perspective view of an inner frame of the pet carrier.

FIG. 6 is a front view of the pet carrier with sides defined by a webbing.

FIG. 7 is a side view of the pet carrier with sides defined by a webbing.

### DETAILED DESCRIPTION

With reference to the Figures, wherein like numerals indicate like parts throughout the several views, a pet carrier 10 for a vehicle (not shown) includes an outer frame 12 and an inner frame 14. The inner frame is slidably coupled to the outer frame along an axis A. The inner frame defines a pet compartment 18. An energy absorbing element 20 is disposed between the inner frame and the outer frame along the axis A.

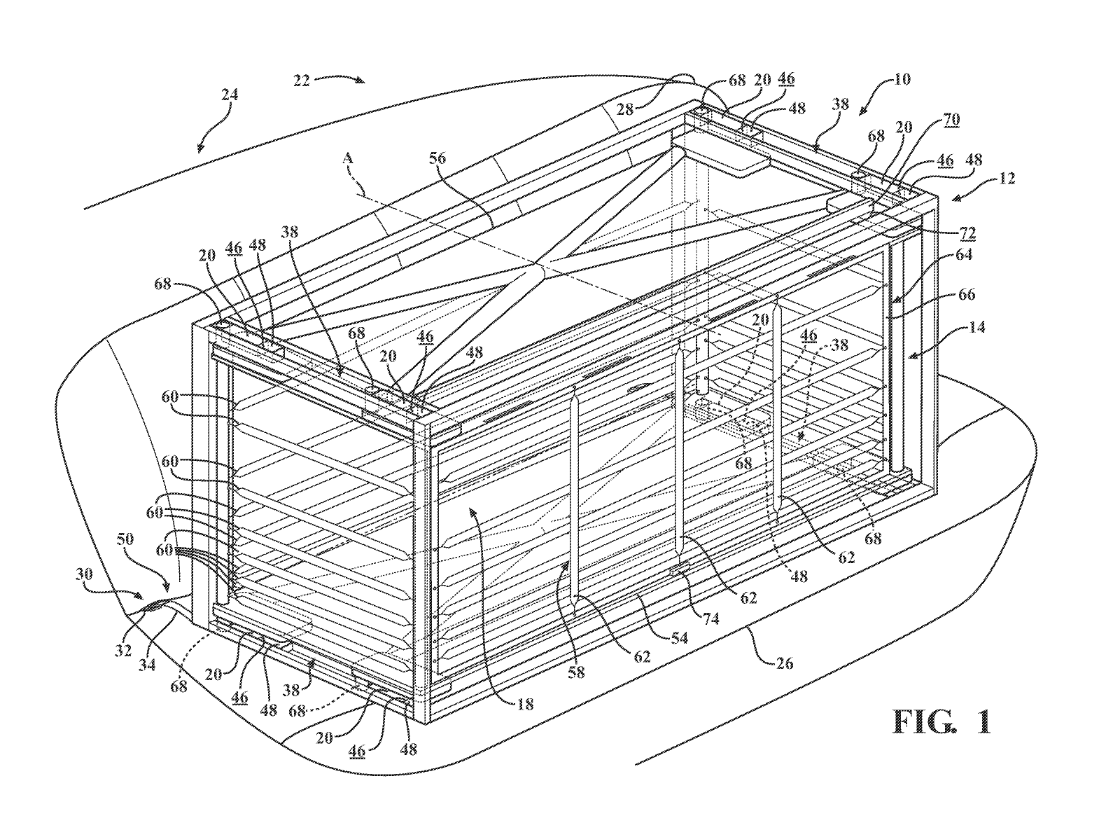

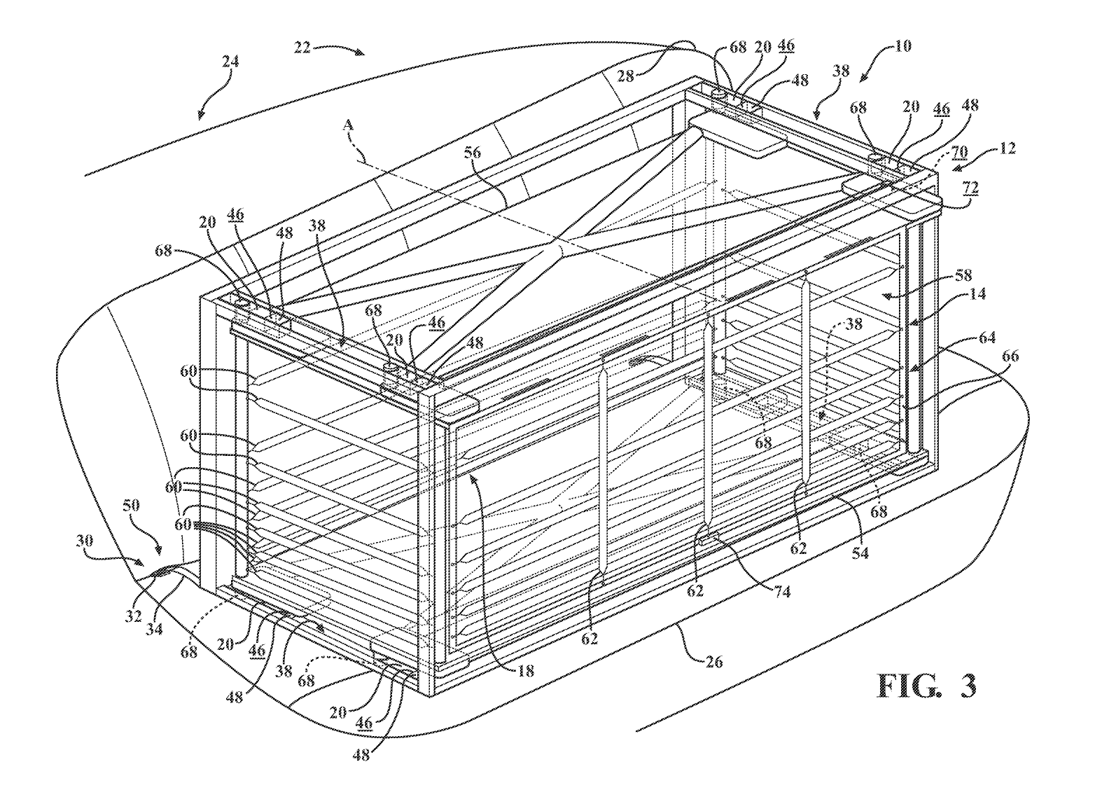

As set forth further below, one or more pets may be stored in the pet compartment 18 during operation of the vehicle. The pet carrier 10 may be deployed from an undeployed position, as shown in FIG. 1, to a deployed position, as shown in FIG. 3, during a vehicle impact. Specifically, the inner frame 14 moves relative to the outer frame 12 and the energy absorbing element 20 is compressed between the inner frame 14 and the outer frame 12 during movement from the undeployed position to the deployed position. The pet carrier 10 may absorb energy during movement from the undeployed position to the deployed position and may reduce the likelihood of injury to the pet from impacting the pet carrier 10. In other words, during the vehicle impact, the pet may impact the inner frame 14 and force the inner frame 14 to move relative to the outer frame 12 to the deployed position. During this movement, the energy absorbing element 20 absorbs energy from the impact of the pet against the inner frame 14. Specifically, during the vehicle impact, the pet may be forced into the inner frame 14 of the pet carrier 10, and the energy absorbing elements 20 may absorb all or part of the energy of the pet to soften the impact of the pet with the pet carrier 10. In this situation, as the pet impacts the inner frame 14, the inner frame 14 may be deployed to the deployed position and may engage the energy absorbing elements 20, e.g., crushing the energy absorbing elements 20, to absorb all or part of the energy from the pet. The energy absorbing elements 20 assist in reducing the peak acceleration of the pet with respect to the pet carrier 10 and softening the impact of the pet with the pet carrier 10, which may reduce injury to the pet.

As shown in FIG. 1, the vehicle includes a vehicle body (not shown) defining a vehicle interior 22. The vehicle body may include a roof (not numbered), a floor (not numbered), and a plurality of pillars (not numbered). The vehicle body may have a uni-body construction, a body-on-frame construction, or any other suitable construction.

With continued reference to FIG. 1, the vehicle interior 22 may include one or more seats 24. For example, as shown in the Figures, the vehicle interior 22 may include a plurality of seats 24 supported by the floor. The vehicle may include any suitable number of seats 24 and the seats 24 may be arranged in any suitable arrangement. For example, as shown in the Figures, the seats 24 may be arranged in a front row (not shown) and a rear row.

The vehicle may accommodate seats 24 of any suitable size. One of the seats 24 may accommodate the pet carrier 10, as shown in FIGS. 1-3. The pet carrier 10 may be of any suitable size to be disposed on any of the seats 24. The seat 24 may be, for example, a bucket seat, a bench seat, or any other suitable type of seat.

With continued reference to FIG. 1, the seats 24 may each include a seat bottom 26. A seatback 28 may extend upwardly from the seat bottom 26 and may recline relative to the seat bottom 26. A base (not numbered) may support the seat bottom 26 on the floor.

With continued reference to FIG. 1, the vehicle may include any suitable restraint system 30. The restraint system 30 of the vehicle may engage the pet carrier 10 to fix the pet carrier 10 to the vehicle.

For example, the restraint system 30 may include an infant seat attachment system 32, e.g., a Lower Anchors and Tethers for Children (LATCH) system. The infant seat attachment system 32 may be attached to a component of the vehicle adjacent to the seats 24, e.g., the vehicle body. The infant seat attachment system 32 may include any suitable number of anchor brackets, i.e., one or more. The pet carrier 10 may be releasably connected to the anchor brackets of the infant seat attachment system, e.g., with a tether 34, as set forth below.

As another example, the restraint system 30 of the vehicle may include a plurality of seatbelt assemblies (not shown). The seat belt assembly may include a locking retractor, a belt engaged with the locking retractor, a clip on the belt, and a buckle releasably lockable with the clip. The belt is extendable and retractable from the locking retractor. Upon sudden deceleration, the locking retractor may lock the belt to the retractor to prevent the belt from extending or retracting relative to the retractor. The belt may be engaged with the pet carrier 10 to releasably connect the pet carrier 10 to the seat 24. Specifically, the belt and clip may be extended through the outer frame 12 of the pet carrier 10, and the clip may be engaged with the buckle to connect the pet carrier 10 to the seat 24.

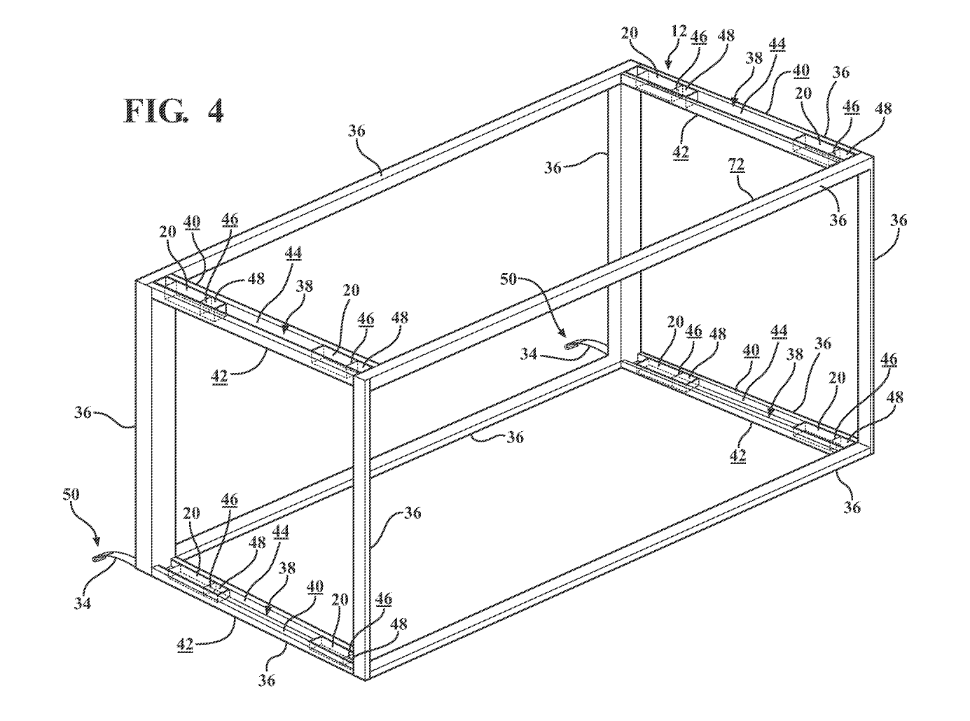

As shown in FIG. 4, the outer frame 12 may include a plurality of outer frame members 36. The outer frame members 36 may be attached to each other in any suitable way, e.g., welding, adhering, or any other suitable attachment method. The outer frame 12 may have any suitable shape, e.g., cube, cuboid, or any other suitable shape.

With continued reference to FIG. 4, the outer frame 12 may include a slot 38 extending along the axis A. The slot 38 may include a first surface 40 and a second surface 42 spaced from the first surface 40 transverse to the axis A. The slot 38 may include a peripheral surface 44 extending from the first surface 40 to the second surface 42. The slot 38 may extend completely through the outer frame 12, or may have a bottom surface (not shown) extending from the first surface 40 to the second surface 42. The slot 38 may have any suitable shape, e.g., oval, rectangle, or any other suitable shape. The outer frame 12 may include any suitable number of slots 38, i.e., one or more.

With continued reference to FIG. 4, the slot 38 includes a stop surface 46. The stop surface 46 is disposed along the axis A and extends transverse to the axis A to limit movement of the inner frame 14 relative to the outer frame 12. As set forth below, the stop surface 46 may engage with the energy absorbing element 20 during the vehicle impact. The stop surface 46 may extend through the slot 38 transverse to the axis A. In other words, the stop surface 46 may extend from the first surface 40 to the second surface 42 of the slot 38. Alternatively, the stop surface 46 may extend from the first surface 40 to the bottom surface. The stop surface 46 may have any suitable shape, e.g., circle, square, or any other suitable shape. The stop surface 46 may be planar, i.e., flat.

The stop surface 46 may be defined on any suitable component. For example, the pet carrier 10 may include a stopper 48 fixed in the slot 38 and including the stop surface 46. The stopper 48 may be fixed in the slot 38 in any suitable manner. For example, the stopper 48 may be press fit against the periphery of the slot 38. Other suitable examples include welding, adhering, fastening, or any other suitable manner. In the alternative to the stopper 48, the stop surface 46 may be defined on an outer frame member 36 of the outer frame 12.

With continued reference to FIG. 4, the outer frame 12 may include a plurality of attachments 50 configured to attach the outer frame 12 to the vehicle. The outer frame 12 may include any suitable number of attachments 50, i.e., one or more. The attachment 50 may be configured to attach to the anchor brackets of the infant seat attachment system. For example, the attachment 50 may be the tether 34, as introduced above, fixed to the outer frame 12 and attachable to the anchor brackets. Alternatively, the attachment 50 may be configured to engage with the belt of the seat belt assembly. For example, a ring fixed to the outer frame 12 may receive the belt.

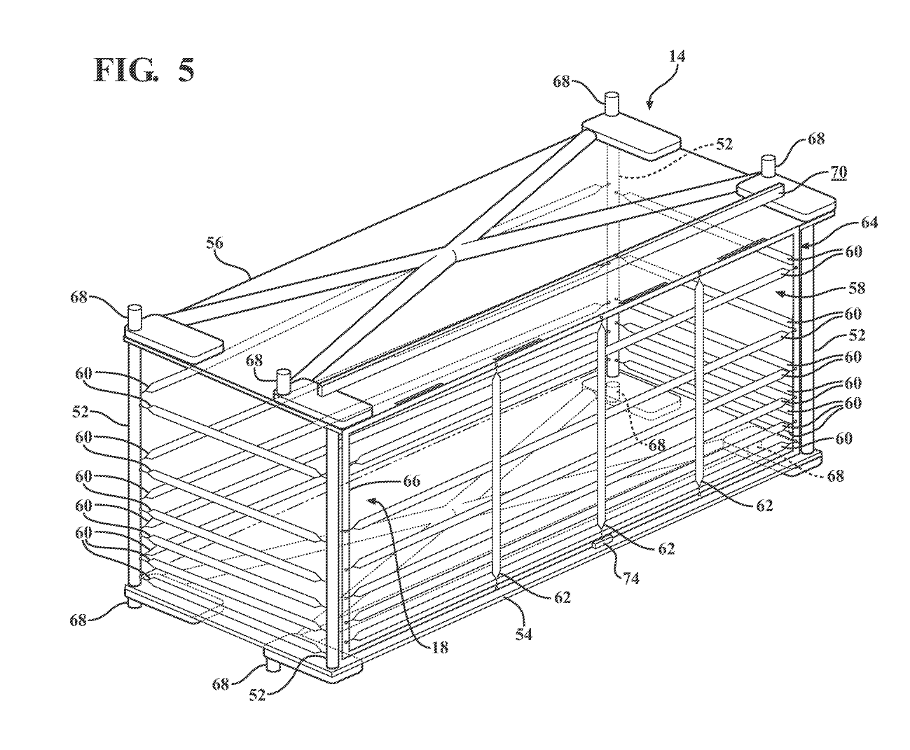

As shown in FIG. 5, the inner frame 14 may include a plurality of inner frame members 52. The inner frame members 52 may be attached to each other in any suitable way, e.g., welding, adhering, or any other suitable attachment method. The inner frame 14 may have any suitable shape, e.g., cube, cuboid, or any other suitable shape. The inner frame 14 may be adjacent to the first surface 40 of the slot 38 on the outer frame 12.

The inner frame members 52 and the outer frame members 36 may be formed of a same or different material. The inner frame members 52 and the outer frame members 36 may be formed of any suitable material. For example, the inner frame members 52 and the outer frame members 36 may be formed of aluminum, nylon, polyvinyl chloride, or any other suitable material.

With continued reference to FIG. 5, the inner frame 14 may include a bottom 54 and a top 56 spaced from each other. The bottom 54 and the top 56 may be formed of any suitable material. For example, the bottom 54 and the top 56 may be formed of nylon, polyvinyl chloride, or any other suitable material. Alternatively, the bottom 54 may include a removable comfort tray, which may be formed of any suitable material, e.g., memory foam, polyurethane, dry fast foam, or any other suitable materials.

As one example, the inner frame 14 may include sides (not shown) fixed to the inner frame 14 and extending about the pet compartment 18. The sides may extend from the bottom 54 to the top 56 of the inner frame 14. In other words, the sides may enclose the pet compartment 18.

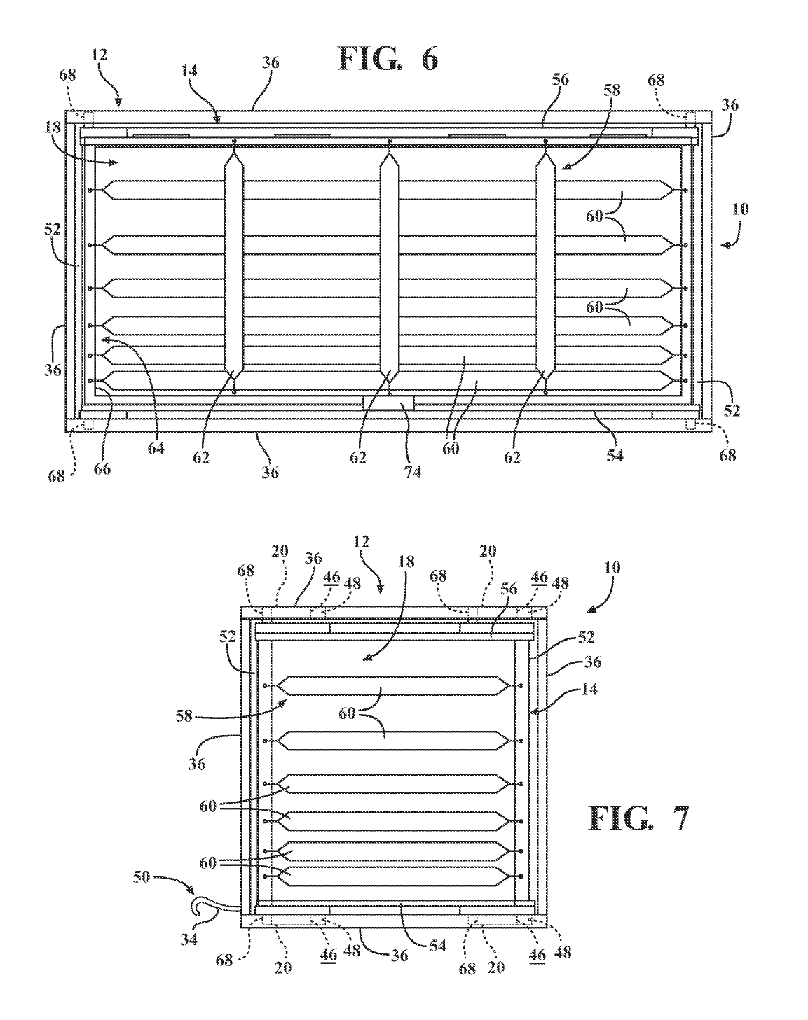

As another example, with reference to FIGS. 6 and 7, the inner frame 14 may include webbing 58 fixed to the inner frame 14 and extending about the pet compartment 18. The webbing 58 may extend from the bottom 54 to the top 56 of the inner frame 14, as shown in FIG. 5. In other words, the webbing 58 may enclose the pet compartment 18. The webbing 58 may stretch when impacted by the pet, which may absorb impact energy from the pet.

As shown in FIGS. 6 and 7, the webbing 58 may include a plurality of segments 60 spaced from each other in a direction from the bottom 54 to the top 56 of the inner frame 14. The segments 60 may each be elongated horizontally. The spacing between each segment may increase in a direction from the bottom 54 to the top 56. In other words, the segments 60 may have a narrower spacing adjacent to the bottom 54 and a wider spacing adjacent to the top 56. Since the spacing of the webbing 58 is narrower adjacent to the bottom 54, during the vehicle impact, the webbing 58 may assist in softening the impact of the pet with the pet carrier 10.

With continued reference to FIG. 6, the webbing 58 may include a plurality of second segments 62 extending transverse to the segments 60, e.g., perpendicular to the segments 60. The second segments 62 may be elongated vertically. The second segments 62 may extend in a common plane with the segments 60. In other words, the second segments 62 and the segments 60 may be coplanar. The second segments 62 may be intertwined with the segments 60 to form a lattice pattern. The second segments 62 may assist in retaining the pet in the pet compartment 18 during the vehicle impact. Alternatively, the second segments 62 may overlap the segments 60.

The webbing 58 may be formed of any suitable material, e.g. from a woven polymer. For example, the webbing 58 may be formed of woven nylon yarn, e.g., nylon 6. Other suitable examples include polyurethane, polyester, spandex, or any other suitable polymer. The woven polymer may include a coating such as silicone, neoprene, urethane, etc.

The webbing 58 may be attached to the inner frame members 52 and the outer frame members 36 in any suitable manner. For example, the webbing 58 may include clips, screws, etc. for attaching the webbing 58 to the inner frame member 52 and the outer frame member 36.

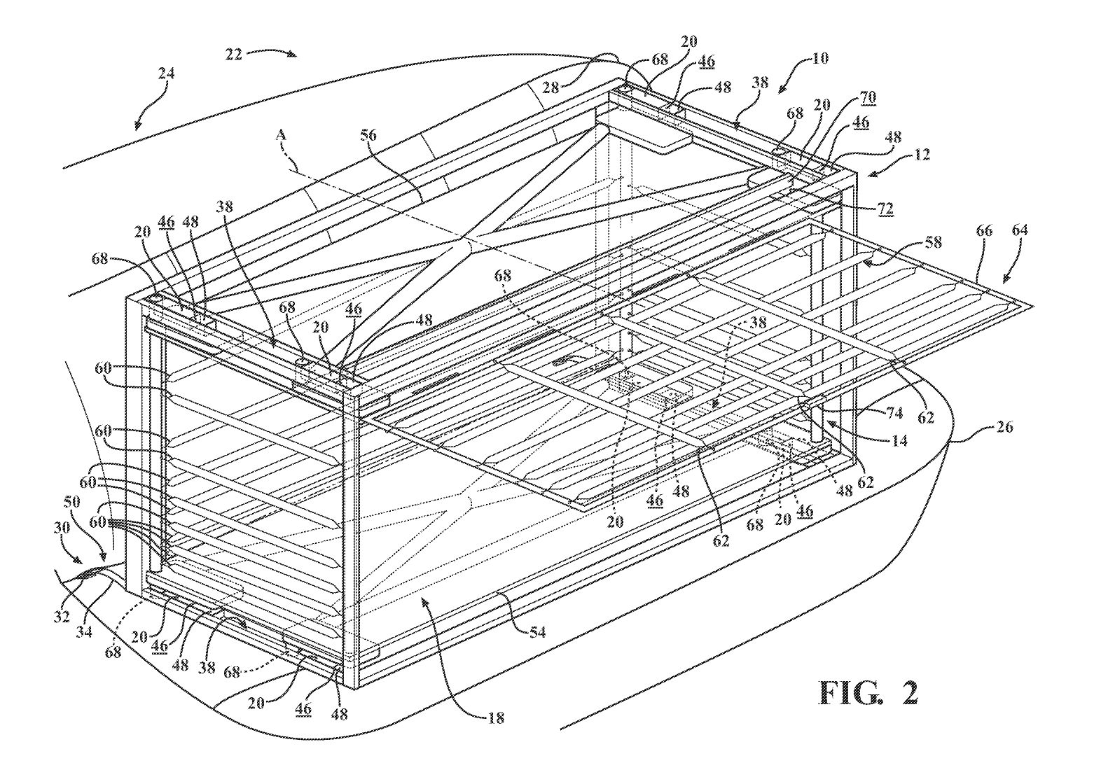

With continued reference to FIG. 5, the inner frame 14 may include at least one door 64. The door 64 may be rotatably coupled to one of the inner frame members 52. The inner frame 14 may include any suitable number of doors 64, i.e., one or more. The door 64 may be moved from a closed position, as shown in FIG. 1, to an open position, as shown in FIG. 2, to allow the pet to enter and exit the pet compartment 18. The door 64 may be on any side of the pet carrier 10, or more than one door 64 may be on more than one side of the pet carrier 10.

The door 64 may be formed of any suitable material. For example, the door 64 may be formed of aluminum, nylon, polyvinyl chloride, or any other suitable material. The door 64 and the inner frame members 52 may be formed of a same or different material.

The door 64 may include a frame 66 and webbing 58 extending across the frame 66. The webbing 58 of the door 64 may be of the same type or a different type than the webbing 58 of the inner frame 14 and the outer frame 12, and the webbing 58 of the door 64 may be attached to the frame 66 of the door 64 in the same way or a different way that the attachment of the webbing 58 of the inner frame member 52 and the outer frame member 36.

The door 64 may include at least one lock 74 between the door 64 and the frame 66. The lock 74 may secure the door 64 in the closed position relative to the frame during the vehicle impact. The lock 74 may be any suitable type of lock. For example, the lock 74 may be a latch lock, a clamp, a clasp, a spring loaded lock, and/or any suitable type of lock.

The lock 74 may be releasably engageable with the inner frame 14 to secure the door 64 in the closed position. For example, the lock 74 may be releasably engageable with the bottom 54, as shown in FIGS. 1, 3, and 5, to secure the door 64 in the closed position. In other words, the lock 74 may be released to move the door 64 from the closed position to the open position, as shown in FIG. 2. Alternatively, the lock 74 may be releasably engageable with at least one inner frame member 52, i.e. one or more, to secure the door 64 in the closed position.

With continued reference to FIG. 5, the inner frame 14 may include a plurality of tongues 68 extending from the inner frame 14 transverse to the axis A. The tongues 68 may be disposed in the slot 38 spaced from the stop surface 46 along the axis A, as shown in FIG. 1. As shown in FIG. 3, as the inner frame 14 moves to the deployed position, the tongue 68 may slide in the slot 38 along the axis A toward the stop surface 46. As set forth below, the tongues 68 may compress the energy absorbing elements 20 against the stop surface 46 during the vehicle impact. The inner frame 14 may include any suitable number of tongues 68, i.e., one or more.

As shown in FIGS. 1 and 3, the inner frame 14 may include a first stop surface 70 and the outer frame 12 may include a second stop surface 72 aligned with the first stop surface 70 along the axis A. During the vehicle impact, the first stop surface 70 may contact the second stop surface 72. The first stop surface 70 may be spaced from the second stop surface 72 by any suitable distance. For example, the first stop surface 70 and the second stop surface 72 may be spaced closer together than the tongue 68 and the stop surface 46. In other words, the first stop surface 70 and the second stop surface 72 may be spaced to limit the displacement of the inner frame 14 with respect to the outer frame 12 during the vehicle impact.

As shown in the Figures, the pet carrier 10 may include more than one energy absorbing element 20. Specifically, as shown in the Figures, the pet carrier 10 may include eight energy absorbing elements 20. The pet carrier 10 may include any suitable number of energy absorbing elements 20, i.e., one or more. The outer frame 12 may include any suitable number of slots 38, each receiving one of the energy absorbing elements 20. The inner frame 14 may include any suitable number of tongues 68, each engaged with one of the slots 38.

As shown in FIG. 1, the energy absorbing elements 20 are disposed in the slots 38 between the inner frame 14 and the outer frame 12. Specifically, the energy absorbing elements 20 are disposed between the tongues 68 and the stop surfaces 46 in the slots 38. As shown in FIG. 1, the energy absorbing elements 20 abut the inner frame 14, i.e., the tongues 68, and the outer frame 12, i.e., the stop surfaces 46. As set forth above, the energy absorbing elements 20 may engage with the tongues 68 and stop surfaces 46 during the vehicle impact. In this situation the energy absorbing elements 20 may be deformed, e.g., crushed, between the tongue 68 and the stop surface 46 as the inner frame 14 slides with respect to the outer frame 12. As the energy absorbing elements 20 are deformed, the energy absorbing elements 20 may absorb all or part of the energy of the pet due to momentum from the vehicle impact.

The energy absorbing elements 20 may be formed of any suitable material. For example, the energy absorbing elements 20 may be formed of crushable foam, e.g. expanded polystyrene (EPS). Other suitable examples include hexcel, expanded polypropylene (EPP), expanded poly urethane (EPU), tear-away metal strips, or any other energy absorbing material.

The energy absorbing element 20 may be removable from the pet carrier 10. In other words, the energy absorbing elements 20 may be removed from the pet carrier 10 and replaced with other energy absorbing elements 20. As one example, the energy absorbing elements 20 may be replaced after the vehicle impact due to deformation. For example, the energy absorbing elements 20 may include a single deformation phase, e.g. plastic deformation. In this situation, the energy absorbing elements 20 may require replacement after any deformation. Alternatively, the energy absorbing elements 20 may include multiple deformation phases, e.g., elastic and plastic deformation. As another example, the energy absorbing elements 20 may be replaced to accommodate various energy absorbing requirements of the pet carrier 10. For example, the energy absorbing elements 20 may be replaced to tune the pet carrier 10 to absorb more or less energy as required.

In operation, the pet carrier 10 is in the undeployed position as shown in FIG. 1, under normal operating conditions of the vehicle. When the vehicle is impacted, the outer frame 12 remains fixed to the seat 24 and the inner frame 14 slides from the undeployed position to the deployed position, as shown in FIG. 3. As the pet moves within the pet carrier 10 due to the momentum of the vehicle impact, the pet may move towards the webbing 58 on the inner frame 14. When the pet impacts the webbing 58, the webbing 58 may stretch to absorb energy from the pet. The webbing 58 may retain the pet within the pet compartment 18. As the pet impacts the webbing 58, the inner frame 14 may slide to the deployed position. When the inner frame 14 slides to the deployed position, the energy absorbing elements 20 are deformed between the tongues 68 and the stop surfaces 46 in the slots 38 absorbing the energy of the pet. The energy absorbing elements 20 may absorb all or part of the energy of the pet. The first stop surface 70 on the inner frame 14 may contact the second stop surface 72 on the outer frame 12 to limit the displacement of the inner frame 14 with respect to the outer frame 12 during the vehicle impact.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A pet carrier comprising:
an outer frame;
an inner frame slideably coupled to the outer frame along an axis, the inner frame defining a pet compartment; and
an energy absorbing element disposed between the inner frame and the outer frame along the axis.

2. The pet carrier according to claim 1, wherein the energy absorbing element abuts the inner frame and the outer frame.

3. The pet carrier according to claim 1, wherein one of the inner frame and the outer frame includes a slot, and the other of the inner frame and the outer frame includes a tongue disposed in a slot.

4. The pet carrier according to claim 3, wherein the energy absorbing element abuts the tongue in the slot.

5. The pet carrier according to claim 3, wherein the slot includes a stop surface and the energy absorbing element is disposed between the stop surface and the tongue.

6. The pet carrier according to claim 5, wherein the energy absorbing element abuts the tongue and the stop surface in the slot.

7. The pet carrier according to claim 1, further comprising sides fixed to the inner frame and extending about the pet compartment.

8. The pet carrier according to claim 1, further comprising webbing fixed to the inner frame and extending about the pet compartment.

9. The pet carrier according to claim 8, wherein the inner frame has a bottom and a top spaced from each other, and the webbing includes a plurality of segments spaced from each other in a direction from the bottom to the top.

10. The pet carrier according to claim 9, wherein the spacing between each segment increases in the direction from the bottom to the top.

11. The pet carrier according to claim 9, wherein the webbing includes a plurality of second segments each extending transverse to the segments.

12. The pet carrier according to claim 11, wherein the segments and the second segments extend in a common plane.

13. The pet carrier according to claim 8, wherein the webbing is formed of fabric.

14. The pet carrier according to claim 1, wherein the pet compartment includes at least one door rotatably coupled to the inner frame and extending along the pet compartment.

15. The pet carrier according to claim 12, wherein the door includes an opening and webbing extending across the opening along the pet compartment.

16. The pet carrier according to claim 1, wherein the inner frame includes a first stop surface and the outer frame includes second stop surface aligned with the first stop surface along the axis.

17. The pet carrier according to claim 1, wherein the outer frame includes an attachment configured to attach to a vehicle.

18. The pet carrier according to claim 1, further comprising a second energy absorbing element disposed between the inner frame and the outer frame along the axis.

19. The pet carrier according to claim 1, wherein the energy absorbing element is removable from the inner frame and the outer frame.
